(19) United States
(12) Patent Application Publication
(10) Pub. No.: US 2010/0276365 A1
(43) Pub. Date: Nov. 4, 2010

(54) System and method for removing organic contaminants from water

(75) Inventors: Robert W. Thompson, Holden, MA (US); John A. Bergendahl, Pomfret Center, CT (US)

Correspondence Address: BURNS & LEVINSON, LLP, 125 SUMMER STREET, BOSTON, MA, 02110, US

(73) Assignee: Worcester Polytechnic Institute, Worcester, MA (US)

(21) Appl. No.: 12/702,992

(22) Filed: Feb. 9, 2010

Related U.S. Application Data
(60) Provisional application No. 61/150,821, filed on Feb. 9, 2009.

(51) Int. Cl. C02F 1/44; B01D 65/02; C02F 1/72

(52) U.S. Cl. 210/636; 210/638

(57) ABSTRACT

A method and system for removing organic contaminants from water by use of a panel of hydrophobic polymer membranes which resist degradation when exposed to aggressive oxidizing solutions and that can be used to decompose the organic contaminants while fostering selective-permeation by the organic contaminants are disclosed.

### CROSS-REFERENCE TO RELATED APPLICATIONS

This application claims priority to co-pending U.S. Provisional Patent Application Ser. No. 61/150,821, filed Feb. 9, 2009, and entitled REMEDIATING MTBE CONTAMINATION WITH HYDROPHOBIC MEMBRANES AND CHEMICAL OXIDATION, which is incorporated by reference herein in its entirety for all purposes.

### BACKGROUND OF THE INVENTION

### Methyl Tert-Butyl Ether

Methyl tert-Butyl Ether (MTBE) is an additive to gasoline that allows a cleaner and more efficient combustion in common gasoline burning engines. Use of MTBE began in 1979, displacing lead-based additives that were used throughout the industry. In 1990, the Clean Air Act Amendments (CAAA) were passed into law requiring that gasoline oxygenates be used in any urban area where there are unhealthy levels of smog and pollution.

The synthetic molecule was initially used in low concentrations, from 0.5 to 3.5 percent by volume. In 1981, the Environmental Protection Agency authorized use of up to ten percent by volume MTBE in gasoline and in 1988, two years before use of oxygenates were mandated, the acceptable level of MTBE in gasoline was increased to 15 percent. In 1993, MTBE was the second most produced organic compound (second only to gasoline) in the U.S.

The oxygen in MTBE reduces the amount of pollution rendered by the combustion of gasoline, by increasing the oxygen-to-fuel ratio and enhancing the octane rating of the gasoline. A study prepared by Systems Application International, Inc. has shown that the use of oxygenated fuels in the concentrations made available to consumers reduces the carbon monoxide production by up to 14 percent. Given the stoichiometry of combustion, the oxygen enrichment of the mixture improves gas mileage, and reduces the amount of hydrocarbon contained carbon that is converted into carbon monoxide.

Many oil refineries across the United States continue to rely on MTBE to help achieve the standards set-forth by the Federal Clean Air Act, which, since 1963, has limited various types of atmospheric emissions throughout the United States in an effort to protect the environment. Eighty-seven percent of the gasoline that is reformulated includes oxygenates containing MTBE. Because of the high concentrations of MTBE in gasoline and the large quantities of gasoline distributed, stored and sold across the country, tremendous volumes of MTBE have been released into the environment contaminating water supplies.

MTBE is highly soluble in water and so MTBE released into the environment associates with ground water to a large extent. At 25 degrees Celsius, the water solubility of MTBE is about 5,000 milligrams per liter for a gasoline that is 10 percent MTBE by weight. This means that any time there is a leak of MTBE, a significant portion of it dissolves into the aqueous environment. The high water-solubility and low sorption of MTBE also results in a significantly faster spread of the compound when compared to other organic components of gasoline when released. This differential in speed of dissemination is depicted in FIG. 1, with the movement of MTBE over a given time being compared to that of BTEX, a combination of volatile organic compounds.

Underground Storage of MTBE

Gasoline is stored in liquid underground storage tanks (LUSTs) at gas stations across the United States. For decades, these tanks were constructed out of steel that was not resistant to corrosion. While the addition of MTBE does not make stored fuels more corrosive, many of these tanks are not properly maintained and, over the course of decades of neglect, they deteriorate.

The storage tanks leak their contents into the ground water in the areas around gas stations. In California, more than twenty public drinking water wells have ceased water production for this reason. Even those tanks that are not in a state of disrepair may leak gasoline due to improper installation, hardware malfunction or tank overflows or spills.

Storage tank leaks have been identified across the country. In the United States alone, releases of gasoline containing MTBE may have occurred from more than 250,000 leaking underground storage tanks, potentially threatening over 9000 community water supply wells. Another report puts the number of confirmed leaking underground storage tank (UST) sites at 539,623. Of the half-million sites recognized by that report, it is estimated that twenty-five percent of the sites include the release of MTBE.

MTBE Releases

Pascoag, R.I.

In Pascoag, R.I., the rock aquifer that the town sits upon and which permeates the town's water supply is completely contaminated by MTBE. Since 2001, MTBE levels in the town's ground water have exceeded the maximum allowable MTBE level set in Rhode Island by a dramatic margin. The limit of 40 μg/L was established by the state branch of the Department of Health. In some cases, tests have yielded concentrations up to 15,000 μg/L. The MTBE level is measured in terms of grams per liter because the measurement is taken as the water is pumped from the subterranean reservoir beneath the town.

Pascoag's drinking water is drawn from a single well and so, with the contamination of that well, the people of Pascoag have been cut off from a water source of their own. The town is being driven toward bankruptcy because the situation with their ground water has forced the townspeople to ship in bottled water and to purchase water from a neighboring town. The purchase of water represents a financial burden of more than $1,000,000.00 a year.

The source of the contamination in Pascoag was a single abandoned gas station. The leak spread gasoline from beneath the gas station and contaminated an area covering nearly twenty acres and over 100 feet into the ground. Since the problem was identified, the EPA—New England Region has appropriated almost two and a half million dollars to the cleanup of MTBE at the Pascoag site. The money has been devoted, in large part, to the installation of on- and off-site remediation equipment. A pilot-scale Biomass Concentrate Reactor (BCR) has been installed in Pascoag. The reactor is capable of treating a flow of five gallons-per-minute and reducing the MTBE levels to within the RI EPA standard of 20-40 parts per billion.

Over the course of the cleanup and remediation efforts, the EPA and the Department of Environmental Management have removed the source of the leak and several thousand yards of heavily contaminated soil. More than eight million gallons of contaminated groundwater have been pumped through the remediation system, which operated almost constantly from 2003 to October 2007. The MTBE from 3,000 gallons of gasoline have been extracted from contaminated groundwater.

Santa Monica, Calif.; Charnock Sub-Basin

In addition to the large-scale release of MTBE in Pascoag, Rhode island another large spill of MTBE has contaminated wells in Santa Monica, Calif. The city receives its drinking water from well-fields which are supplemented by water from the Colorado River. Leaks from underground gasoline storage tanks, above ground storage tanks, and pipelines have contaminated seven of the wells in two of these well-fields. The contamination was discovered in the Arcadia Well-field and the Chamock Sub-basin in 1995 during water sampling by the city.

The concentrations of MTBE in the well-water in the Acadia Well-field are much lower than in the Pascoag groundwater, ranging from levels between 20 ppb to 85.5 ppb. The regional branch of the EPA directed Mobil Oil, the proprietors of the USTs, the above ground tanks, and pipelines, to fund and lead a cleanup of the contaminated area. The gas station to which the leaking tanks and pipelines were connected was removed, along with several thousand cubic yards of contaminated soil. An activated carbon bed remediation system began pumping MTBE laced groundwater in October, 1997. The water containing MTBE passes through three beds of activated carbon before being reintroduced to the public water system, meeting EPA standards.

The Chamock Sub-basin experienced significantly more contamination, around 610 ppb within the wells. Twenty-six leaking USTs and two leaking pipelines have been removed in connection with MTBE contamination of the Charnock Sub-basin. Contaminated soil was also removed from the site.

Dallas Tex.; Lake Tawakoni

Dallas, Tex. has also suffered from the effects of MTBE being introduced into the environment in large quantities. In March of 2000, a gasoline pipeline, the Explorer Pipeline, was found to have a rupture 50 inches long that was leaking into East Caddo Creek. East Caddo Creek is a tributary for Lake Tawakoni, running twenty-eight miles from the site of the gasoline pipe rupture to the lake inlet. Steps were immediately taken to limit the spread and impact of the spill; floating and cofferdams were used in conjunction with vacuums to staunch the flow of the gasoline and remove it from the watershed. However, runoff rainwater served as a driving force to disseminate the spilled gasoline. Within three days of the discharge, the gasoline had traveled almost thirty miles.

Lake Tawakoni was used as a source of water for the Dallas Water Utilities (DWU) which is responsible for distributing water to millions of people within the limits of the City of Dallas. The gasoline contained MTBE and upon discovery of that fact, the lines pumping water from the lake were turned off. The best estimate offered by the DWU for the volume released from the pipe rupture is a half-million gallons of gasoline, which left the DWU a deficit of 190 million gallons each day. The problem was solved at significant expense through the construction of an underground pipeline to another lake, Lake Ray Hubbard.

Health Effects

The health effects of MTBE are not yet completely understood and it is not yet certain whether or not it should be classified as an imminent human health risk. It is categorized by the EPA as a possible carcinogen to humans. Prolonged exposure to highly concentrated MTBE vapors has resulted in cancerous polyp formation on the kidneys in rats as well as displaying other, non-cancerous, complications. MTBE has a number of less severe effects on humans, ranging from nose and throat irritation to headaches to nausea and vomiting. In Pascoag, R.I. many of these symptoms were exhibited throughout the community. Individuals suffered from migraine-grade headaches. Other denizens began to develop respiratory problems, wheezing heavily and often. In some of the worst cases of exposure, victims developed open sores and blisters on their lips.

MTBE contamination of soil and ground water is occurring throughout the country. The issue is being addressed in an effort to assuage the problems that a good portion of the population is experiencing with regard to one of their basic needs, drinking water. Degradation of MTBE by advanced oxidation offers a means of rectifying the problem. Fenton's oxidation has proven to be very effective in breaking down MTBE into a number of different products.

Remediation

Unfortunately, the problem of MTBE contamination in ground water and wells across the United States will not rectify itself. MTBE is resistant to biodegradation and does not break down to a large extent overtime. MTBE is also highly soluble in water and so does not readily separate out of aqueous solution.

Several techniques are currently being used to cleanse MTBE contamination from ground water and soil. Soil vaporization extraction (SVE) draws air through the unsaturated zone of contaminated aquifers, volatizing the contaminants. The vaporized MTBE is then normally removed from the air stream by adsorption onto granular activated carbon or direct incineration. When MTBE is dissolved in water, it must be pumped out of the wells for treatment. Granular activated carbon (GAC) can be used to remove MTBE from solution, however, GAC is limited in its ability to adsorb MTBE.

Advanced oxidation processes have been shown to oxidize up to 99% of MTBE within five minutes of the onset of treatment. This method is one of the more promising means of dealing with and destroying MTBE, but it requires the separation of MTBE from the water supply so that the oxidizing agents and the products of oxidation do not remain in the water stream.

Zeolite Separation

New technologies are being developed and investigated in an effort to deal with the problem of MTBE contamination. Zeolites, which are nano-porous, crystalline alumino-silicates with framework structures containing silica and alumina tetrahedra, have been explored as a means of selectively removing MTBE from a water stream. Hydrophobic and organophillic zeolites repel water while allowing the transport of MTBE. The hydrophobic nature of the compounds comes from the particular arrangement of the silica tetrahedra, relative position to alumina, and the amount of alumina tetrahedra in the structure. Silicate structures are comprised of two types of groups, silanol sites, which is a silicon group bonded to an hydroxyl group (≡SiOH), and a pair of silicon atoms bonded to an oxygen atom (≡Si—O—Si≡). The silicon-oxygen-silicon bonds are not polarized and so should repel polarized water molecules. This repulsion of water molecules from the surface of the crystalline silicates creates hydrophobic zeolite particles. The rigid crystalline structure of the zeolites offers pores that can adsorb organic compounds, such as MTBE. In experiments, hydrophobic zeolites have performed better in terms of MTBE adsorption and removal than granular activated carbon beds. Once saturated with organic MTBE, the zeolite bed can be cleansed through advanced oxidation by hydroxyl radicals, extracting and mineralizing the targeted compound.

This zeolite technology is not, however, the direct answer to the problem of cleansing MTBE contaminated water. The transition from laboratory experiments to industrial scale use of zeolites belies a major flaw in the technology. The same nano-porous structure and small particle size which allows a bed of hydrophobic zeolite to selectively attract MTBE prevents the passage of a stripping agent during remediation. Prohibitively large pressure drops are experienced across these beds, due to energetic demands and other inefficient operating parameters. Pressure drop in a packed tower is determined by Equation 1:

$$Pressure Drop in a Packed Tower \frac{d p}{d L} = \frac{150 μ {v ( 1 - ɛ )}^{2}}{{( {Φ}_{s} {D}_{p} )}^{2} {ɛ}^{3}} \qquad Equation 1$$

dp/dL defines the pressure drop per unit length. p represents the viscosity of the filtrate through the zeolite particle bed. U represents the linear velocity of the filtrate based on the area of the filter. ε is the porosity of the zeolite particles, dependent upon the ratio of alumina to silica. The factors determined relating to sphericity or shape and particle size are Φs and Dp. Because the particle size is accounted for in the denominator as a squared term, the very small size of the zeolite particles offers a tremendous pressure drop across a scaled-up bed for the removal of MTBE from a water supply. Pumps must be operated at a sufficiently high rate to overcome this pressure drop, yielding the aforementioned prohibitive energetic demands of such a large-scale effort.

### BRIEF SUMMARY OF THE INVENTION

The present invention is a method and system for removing organic contaminants from water by use of hydrophobic polymer membranes which resist degradation when exposed to aggressive oxidizing solutions that can be used to decompose the organic contaminants while fostering selective-permeation by the organic contaminants.

The present invention includes a method for removing organic contaminants from water by passing a water stream through a hydrophobic and organophilic polymer membrane, such that the membrane repels the water stream while allowing organic contaminants to pass through the membrane; separating the organic contaminants from the water, and reacting the organic contaminants with an oxidation reagent. The method optionally further includes periodically cleaning the surface of the polymer membrane. The membranes can be cleaned by washing with low-pH (acidic) solutions, which will dissolve inorganic precipitates. Alternatively, the membranes can be cleaned by washing with solutions containing chelators to resolubilize inorganic precipitates. The frequency of cleaning necessary will be dependent on the water quality and required chemical doses.

The polymer membrane can be e.g., polytetrafluoroethylene (Teflon®). Other membranes suitable for use in the method of the invention include polypropylene membranes and nylon membranes. The membrane can have pore sizes of approximately 0.45 microns.

The oxidation reagent is composed of ferrous iron and hydrogen peroxide. The pH of the ferrous iron and hydrogen peroxide solution is about 3. The oxidation reagent reacts with the contaminants to produce hydroxyl radicals. Example organic contaminants include methyl-tert-butyl ether (MTBE).

### BRIEF DESCRIPTION OF THE DRAWINGS

The present invention is illustratively shown and described in reference to the accompanying drawing in which:

FIG. 1 is a depiction of the differential of the speed of spill and expansion dissemination according to an object of the invention;

FIG. 2 is a depiction of the degree of hydrophobicity exhibited by a membrane according to an objection of the invention;

FIG. 3 is a photographic depiction of a goniometer according to an object of the invention;

FIG. 4 is a photographic depiction of a test apparatus according to an object of the invention;

FIG. 5 is a photographic depiction of the threaded flange of the test apparatus according to an object of the invention;

FIG. 6 is a graph showing test results of MTBE transport across membranes;

FIG. 7 is a graph showing test results the removal of MTBE from a solution;

FIG. 8 is a goniometer photograph of pre-oxidation Teflon;

FIG. 9 is a goniometer photograph of pre-oxidation nylon;

FIG. 10 is a goniometer photograph of pre-oxidation PVDF;

FIG. 11 is a goniometer photograph of pre-oxidation polypropylene; and

FIG. 12 is a goniometer photograph of post-oxidation Teflon.

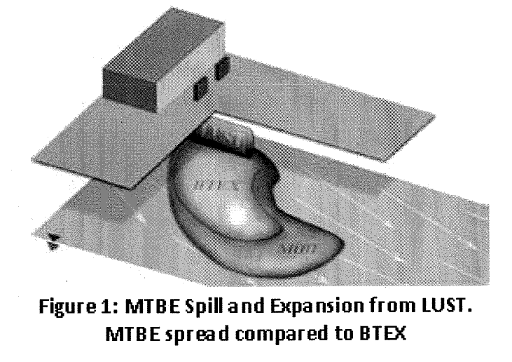

### DETAILED DESCRIPTION OF THE INVENTION

### Membrane Separation

Filtration on a molecular-scale, which is termed ultrafiltration, is possible through the use of semi-permeable membranes. Membranes can effectively retain a particular solute or solvent while a free-energy disparity caused by concentration gradient drives another solute from one side of the barrier to the other. Pore-size limits what molecules can actually pass through the membrane, along with the chemical makeup of the membrane and the solute of interest. Just as a molecule that is too large to pass through a membrane will be maintained on a particular side of the membrane, a molecule that is repelled by the surface chemistry will not pass through. Hydrophobic membranes prevent the transmission of water molecules across the diaphragm of interest. Organophillic membranes allow the passage of organic compounds. Polymer membranes offer a platform where the properties of hydrophobicity and organophillicity can be combined. Such a combination theoretically allows for the development of a means for selectively removing MTBE from a water source, while making use of materials that are chemical resistance to aggressive solutions.

Hydrophobicity

The hydrophobic nature of a material is primarily governed by several factors. The first of those factors is the chemical makeup of the membrane and the polarity of the bonds within the molecules. The molecular structure within the membrane also plays part in the determination of the hydrophobicity of a material. Further hydrophobic nature is realized through the topography of the membrane surface.

The electronegativity difference between the oxygen and hydrogen in water molecules creates a pair of dipole moments and a molecule that is, overall, polar. The positive hydrogen dipoles within water molecule tend to associate with the negative oxygen dipoles, forming what are termed “hydrogen bonds.” The energetic stability derived from the formation of hydrogen bonds leads to a tendency for the maximum number of such bonds to form. The presence of non-polar molecules among polar molecules prevents the formation of hydrogen bonds, developing a repulsive force between two such phases. It is partially this repulsive force that lends hydrophobic character to a material. The liquid will bead up on the surface to minimize the solid-liquid interfacial area.

If a molecule has polar as well as a non-polar portions, the structure must arrange and orient the molecules in a manner sufficient to prevent the interaction of water with the hydrophilic regions. Hydrophilic molecules on the membrane surface increase the wettability of the membrane as a substrate. Additionally, formation of hydrophilic channels through the membrane would foster the movement of water through the membrane, countering the effect of the hydrophobic regions.

The microscopic surface topography of a membrane can increase the hydrophobicity of a material by allowing further reduction in the size of the interfacial area between the liquid and the membrane. Roughness is characterized by either “peaks” or “pillars” of varying size on the membrane. Increasing the roughness of a hydrophobic surface can increase its hydrophobicity dramatically. A water droplet will rest on top of the peaks or pillar tops of a rough surface, allowing air to fill the valleys between the membrane surface and the water droplet. The limited surface contact allows the formation of increasingly spherical beads of water.

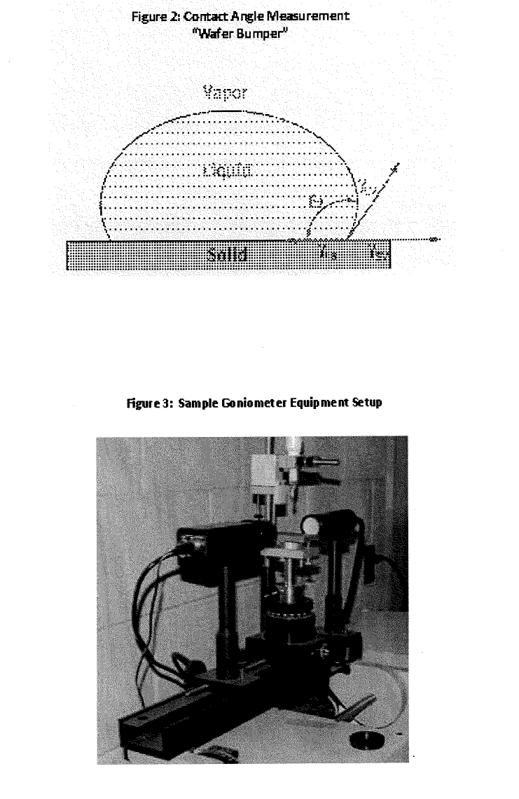

The degree of hydrophobicity exhibited by a membrane can be measured in terms of water wetting contact angle between the surface and a line tangential to the drop, as can be seen in FIG. 2. A hydrophilic surface yields a contact angle less than 90 degrees while hydrophobic surfaces display contact angles greater than 90 degrees. Surfaces with contact angles in excess of 150 degrees are considered to be superhydrophobic.

Organophilicity

Organophilic character is a measure of how readily a material associates with organic compounds. Hydrophobic compounds are also organophilic because of the non-polarity of the molecules and the organics. This characteristic is of significant import, because MTBE is an organic compound, and so, for it to permeate a membrane, that membrane must be organophilic.

Polymer Membranes

Polytetrafluoroethylene (Teflon®)—Many of Teflon's properties suit it for use in a membrane designed to foster the transport of MTBE while restricting the passage of water. It is also well-suited for use with aggressive solutions such as the oxidizing solutions that will be necessary for the destruction of the MTBE after it has crossed the membrane substrate. PTFE is chemically inert, which means that it does not readily react to or interact with other substances which can help to prevent its degradation while oxidation is taking place. It also has a high resistance to heat that will allow it to maintain its form when heat is evolved from oxidation-reduction reactions. These characteristics offer a PTFE surface that is non-corrosive.

Teflon is comprised of a chain of non-polar monomers bearing the formula —(CₙF₂ₙ)—. The nonpolar monomer lends itself to a non-polar and therefore, hydrophobic and organophilic, polymer chain. The contact angle for PTFE ranges from 98.5 degrees to 105 degrees depending upon the manufacturing technique used in the development of the Teflon, as different techniques offer different surface topographies. Teflon resin can be precipitated, from aqueous solution, in a granular form if a dispersing agent is not used. If a dispersing agent is used in solution in conjunction with agitation, a particulate form of the resin develops. Either form carries the characteristics necessary for allowing the transport of MTBE while resisting destruction by strong oxidizing agents.

Nylon—Nylon is naturally hydrophilic with a water contact angle of 70 degrees. It is a crystalline polyamide polymer. The crystalline network of the polymer offers a degree of strength to membranes made from it. Nylon is resistant both to heat and a variety of chemicals, including weak acids. Nylon, however, is attacked by strong acids and in some cases dissolves in the presence of such solutions. The surface chemistry of nylon membranes can be altered in order to render it hydrophobic. Contact angles of around 120 degrees are possible with nylon membranes that have received such treatment.

Polyvinylidene Diflouride—Polyvinylidene diflouride, or PVDF, is a fluoropolymer resistant to chemical, including strong acids, and thermal degradation. The polymer chain is comprised of —(CH₂CF₂)ₙ— monomers. The wetting contact angle for 18MΩ water on PVDF is 71.8 degrees. This means that the surface of a PVDF membrane exhibits slightly hydrophilic behavior and, for comparison, Teflon is more than 137% less water-wettable than is PVDF.

Polypropylene—Polypropylene is formed by the linkage of —(C₂H₂ₙ)— component monomers, which elongates in a linear fashion when propylene gas is introduced to an appropriate solid catalyst. It is hydrophobic with a contact angle of 105 degrees and chemically resistant to attack by strong acidic solutions. However, polypropylene is susceptible to solutions containing strong oxidizing agents and so may degrade in the presence of such solutions.

Fenton's Oxidation

There are a several different advanced oxidation processes. These processes make use of hydrogen peroxide or titanium dioxide and ultraviolet radiation, ozone or iron to generate hydroxyl radicals. The hydroxyl radicals are of sufficiently high oxidation state to oxidize organic compounds, such as MTBE, degrading them to benign products. The Fenton oxidation process is a specific reaction that utilizes hydrogen peroxide and ferrous iron at low pH values (pH˜3) to produce the desired hydroxyl radicals.

Fe²⁺+H₂O₂→Fe³⁺+.OH+OH⁻ Equation 2

FeOH⁺+H₂O₂→Fe³⁺+.OH+2OH⁻ Equation 3

The hydroxyl radicals then react with the MTBE that is in the solution. The primary reactions of hydroxyl radicals with MTBE are as follows.

(CH₃)₃COCH₃+.OH→(CH₃)₃COCH₂*+H₂O Equation 4

(CH₃)₃COCH₃+.OH→CH₂(CH₃)₂COCH₃+H₂O Equation 5

There are a number of other reactions that occur in solution with the Fenton oxidation reagents. Hydrogen peroxide and ferrous iron interact with the other components of the solution in up to thirty different minor reactions. The hydroxyl radicals also participate in up to twenty-seven different minor reactions. The major products of the degradation of MTBE by hydroxyl radical oxidation include tert-butyl formate, tert-butyl alcohol, acetone, methyl acetate, and, formaldehyde.

The reaction of Fe²⁺ with hydrogen peroxide occurs quite rapidly. However, the Fe³⁺ that is produced by this reaction also reacts with hydrogen peroxide in a much slower reaction to produce hydroxyl radicals.

Fe³⁺H₂O₂→Fe²⁺+HO₂*+H⁺ Equation 6

Fe^{III}(HO₂)²⁺→Fe²⁺+HO₂⁺ Equation 7

Fe^{III}(HO)(HO₂)²⁺→Fe²⁺HO₂*+OH⁻ Equation 8

As the reaction progresses, the degradation of MTBE slows considerably as Fe²⁺ begins to compete with the byproducts of the minor reactions for hydrogen peroxide and the much slower reaction of Fe³⁺ with hydrogen peroxide. With fewer hydroxyl radicals available, fewer oxidation reactions can occur. Additionally, the products of the various reactions compete with the MTBE to react with what hydroxyl radicals are available. Because of this, the degradation of MTBE slows quickly after the beginning of the reaction, breaking down up to 99% of the MTBE in the first five minutes of latency time, but never completely eradicating the contaminant.

Methodology

Objective 1: Membrane Viability

The characteristics of each polymer membrane acquired for the purpose of this investigation had to be tested to ensure that they were appropriate for the separation of MTBE from a water supply while also preventing the transport of the oxidizing solution into the water supply. The membranes were tested for hydrophobic character, ability to maintain hydrogen peroxide on one side of the membrane, and ability to prevent the passage of iron ions.

Four polymer membranes were obtained for testing over the course of the project. Samples of polyvinylidene diflouride membrane tubing were procured from the stores of the Worcester Polytechnic Institute Civil Engineering Department. Three other membranes were ordered from the General Electric Osmonics Labstore. PTFE (Teflon) laminated membranes, Nylon, and polypropylene were purchased. Each of the membranes purchased from GE Osmonics were marketed as hydrophobic as well as having a high resistances to aggressive solutions. The Teflon membranes ordered were disks 25 mm in diameter and had 0.45 micron pores. The part and model number were 1215492 and F04LP02500 respectively. The Nylon membrane ordered were also disks with 0.45 micron pores, but were 47 mm in diameter, which had to be cut down for use in the apparatus. The part and model numbers were 1237909 and R04SH04700 respectively. Polypropylene membrane was purchased in sheets. The pores, as with the other membranes, were 0.45 microns in diameter. The part and model numbers were 1225933 and M04WP320F5 respectively.

Hydrophobicity

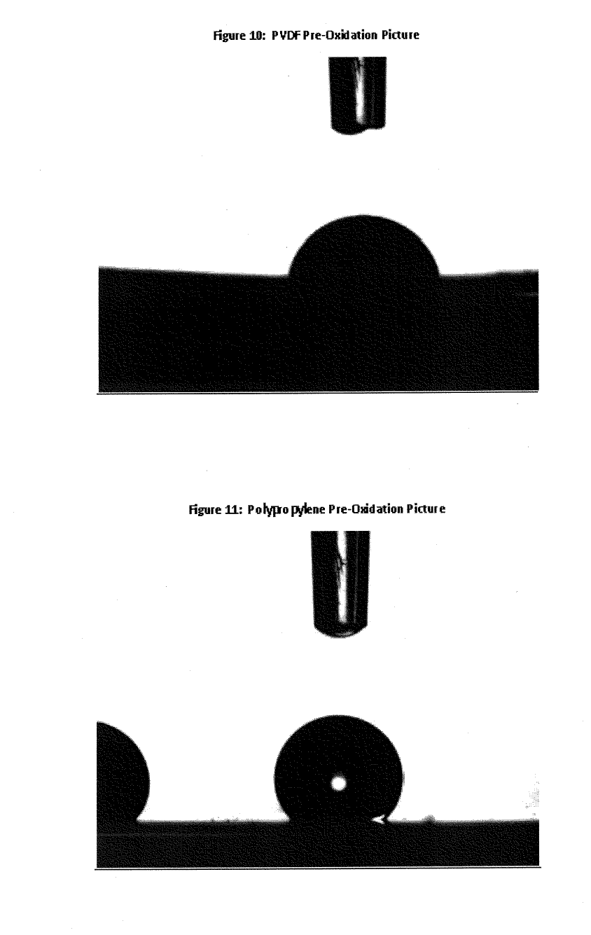

A series of tests were done in order to assess how each of four membranes interacts with liquid water. Teflon, Nylon, polypropylene, and PVDF membranes were tested. All of the membranes were marketed as having hydrophobic character. The wettability of the membranes was tested from a macroscopic standpoint through a drop-wise test. It was also quantified in terms of the water contact angles of the membranes, which were measured by a goniometer (FIGS. 8-11).

For use in the separation of MTBE from a water supply employed in the methods and system of the invention, the polymer membranes must be hydrophobic. If the membranes allowed the passage of water, then the water supply undergoing remediation would be able to pass into the oxidizing solution used to decompose the MTBE and the water in the oxidizing solution would be able to pass into the water supply to achieve equilibrium with regard to the MTBE concentration gradient. The pores of the membrane must be large enough to allow the passage of MTBE and so can not be small enough to restrict the movement of water molecules. Therefore, the membrane chemistry and surface topography must repel water.

Drop-Wise Testing

The wettability of the membranes was visually evaluated with water as well as a hydrogen peroxide solution. This base level investigation was used to identify, at the earliest possible stage, if any of the membranes was actually hydrophilic. Conclusions were drawn about the membrane wettability based on the shape of the water bead on the membrane surfaces.

A 1-to-200 μL pipette was used to uptake and deposit 2 μL droplets of water onto each of the membranes, which had been placed onto a flat countertop. A 30% hydrogen peroxide solution was then used to run the same experiment. Procedure 1 was followed to for the execution of the experiment.

Procedure 1: Drop-Wise Testing Procedure
Place the membranes on the lab surface and ensure that the membranes are flat
Prepare a 1-to-200 μL pipette by affixing the appropriate size tip and setting it to a volume of 4 μL
Fill a 50 mL beaker with approximately 25 mL of 18 MΩ E-Pure water
Draw a sample of water and carefully excrete a droplet onto the surface of the membrane
Drop several beads of water onto each membrane
Evaluate and record the shape of the beads of water immediately after deposition
Allow the beads of water to stand on the membranes for a period of ten minutes
Record any visible change in the shape of the water beads
Repeat the entire experiment from the first step with new membranes and a 30% hydrogen peroxide solution

The drop-wise testing experiment was used to identify the wettability of the membranes from a macroscopic viewpoint. Water-droplets 4 μL in size were pipette onto each of the membranes. The shape of each bead was then evaluated by the naked eye immediately after the drop was placed, and then again after a period of ten minutes to see if exposure to water had increased the wettability.

Four membranes were tested over the course of the experiment: a Teflon membrane, a polypropylene membrane, a polyvinylidene diflouride, and a Nylon membrane. As reported in Table 1, the Teflon, polypropylene, and Nylon membranes all displayed limited wettability. This conclusion was drawn from the spherical form of the beads of water; the droplets placed on each of the aforementioned membranes were repelled from the surface and limited the solid-liquid interface by taking on such a shape. The results of the PVDF membrane test, however, stood in stark contrast to those of the other membranes.

While the water droplet that was placed onto the PVDF membrane took on a definite form, it did not approximate a sphere. The water-bead on the PVDF membrane took on the shape of a hemisphere. Given that the amount of water deposited on each membrane was the same and the different structure of the two types of beads observed, it was concluded that there was a significantly larger solid-liquid interfacial area for the polyvinylidene diflouride (PVDF) membrane when compared to the others. The shape of the water droplet on the PVDF membrane indicates that the membrane was more hydrophilic and less hydrophobic than the other membranes tested. A more definitive assessment could not be conducted due to the small scale and observations based on the unaided eye.

TABLE 1
Drop-Wise Testing Results
Drop-Wise Testing

| | Test Liquid - 4 NL Drop | | | |
|---|---|---|---|---|
| | 18 MA E-Pure Water | | 30% | H2O2 |
| Test Membrane | After Drop | 10 Min. | After Drop | 10 Min. Elapse |
| 0.45 μm Pore | Well-Defined | Well-Defined | Well-Defined | Well-Defined |
| Nylon | Drop, Limited | Drop, Limited | Drop, Limited | Drop, Limited |
| | Wetting | Wetting | Wetting | Wetting |
| 0.45 μm Pore | Well-Defined | Well-Defined | Well-Defined | Well-Defined |
| Teflon | Drop, Limited | Drop, Limited | Drop, Limited | Drop, Limited |
| | Wetting | Wetting | Wetting | Wetting |
| 0.45 μm Pore | Well-Defined | Well-Defined | Well-Defined | Well-Defined |
| Polypropylene | Drop, Limited | Drop, Limited | Drop, Limited | Drop, Limited |
| | Wetting | Wetting | Wetting | Wetting |
| 0.45 μm Pore | Visual Wetting, | Visual Wetting, | Visual Wetting, | Visual Wetting, |
| Polyvinylidene | Poorly Formed | Poorly Formed | Poorly Formed | Poorly Formed |
| Diflouride | Drop | Drop | Drop | Drop |

Four drops were placed on each membrane and allowed to stand for ten minutes. No difference was observed from one drop to the next on a particular membrane. Time exposure did not appear to affect the form of the beads or the wettability of the individual surfaces. The membranes were also tested with a hydrogen peroxide solution with the same results. The observations about the droplet shapes and apparent wettability of the membranes are reported in Table 1. In order to determine if the PVDF membrane was hydrophobic or not and to allow a comparison of the membranes that had demonstrated hydrophobic character, the contact angle of a bead of water on each of the membranes was measured.

Contact Angle Measurement

The contact angles for the membranes were determined to quantify the hydrophobicity of the membranes with a goniometer. A goniometer is a camera that magnifies and captures the image of a droplet on any desired surface, supported on an adjustable platform between the camera and the opposing lantern. The camera, platform, lantern, and automated water dispensing syringe can be seen in FIG. 3. The captured digital image is analyzed using computer software to determine the contact angle exhibited by a membrane. The contact angle was measured repeatedly to allow a mean value to be determined.

Procedure 2: Goniometer Testing
Turn on the computer, camera, pump, and lantern
Load the automated syringe from a 50 mL beaker filled with 18MΩ E-Pure water
Place the membrane on the goniometer surface and ensure that the membrane is flat
Adjust the camera to frame the surface of the membrane
Enter the desired water droplet size into the computer software interface
Output a 4 μL water droplet onto the membrane, moving the platform-bound membrane upward or downward as necessary to allow the droplet to release
Manipulate the computer software to compute the contact angle
Move the platform laterally to present an unmarred section of membrane fills the camera frame
Repeat all previous steps until five contact angle measurements have been resolved for each membrane
On the final droplet for each membrane, take a picture of a droplet to have visual evidence for later reporting

A goniometer was utilized to measure the contact angle of water droplets placed onto the polymer membranes. A measurement was calculated for five drops per membrane, allowing a mean contact angle to be determined. The calculated contact angles as well as the mean values are reported in Table 2. Care was taken to use forceps to place the membranes on the measuring platform so that no skin oils would alter the results.

TABLE 2
Contact Angle Measurement from Goniometer Testing
Goniometer Contact Angle Measurements

| | 0.45 μm | 0.45 μm | 0.45 μm | 0.45 μm Pore |
|---|---|---|---|---|
| Test | Pore | Pore | Pore Poly- | Polyvinylldene |
| Membrane | Nylon | Teflon | propylene | Diflouride |
| Trial 1 | 121.0 | 127.2 | 118.8 | 74.6 |
| Trial 2 | 119.8 | 107.3 | 126.7 | 96.7 |
| Trial 3 | 119.7 | 124.2 | 127.8 | 89 |
| Trial 4 | 122.4 | 115.7 | 136.9 | N/A |
| Trial 5 | 125.5 | 126.7 | 139.4 | N/A |
| Average | 121.7 | 120.2 | 130.7 | 86.8 |

As reported in Table 2, the testing of the Nylon membrane yielded a range of contact angles from 119.7 to 125.5 degrees. The mean value for the five measurements was 121.7 degrees, which is greater than 90, reaffirming the hydrophobic character observed in the drop-wise test. Falling halfway between ninety degrees and 150 degrees, the cutoff for super-hydrophobic character, Nylon exhibits significant hydrophobic behavior.

The Teflon membrane offered contact angle measurements from 127.2 degrees to 107.3. The mean value for the contact angle of Teflon was 120.2 degrees. The hydrophobic nature of the Teflon membrane was essentially equivalent to that of the Nylon membrane.

The polypropylene membrane rendered the highest contact angle and, therefore, the greatest hydrophobic character. Individual measurements ranged from 118.8 degrees to 139.4 degrees and the mean value was 130.7 degrees.

Only three measurements could be taken for the PVDF membrane. Those measurements ranged from 74.6 degrees to 96.7 degrees. The average value of the PVDF contact angle was 86.8 degrees. Based on those measurements, the PVDF membrane that was tested was not hydrophobic.

The polypropylene membrane has the greatest ability to resist the wetting of its surface, however, that classification does not, in and of itself, make the polypropylene membrane the best suited for use in removing MTBE from a water source. Because of the slightly hydrophilic nature of the PVDF membrane, it was not used in any further tests.

Apparatus-Membrane Seal Testing

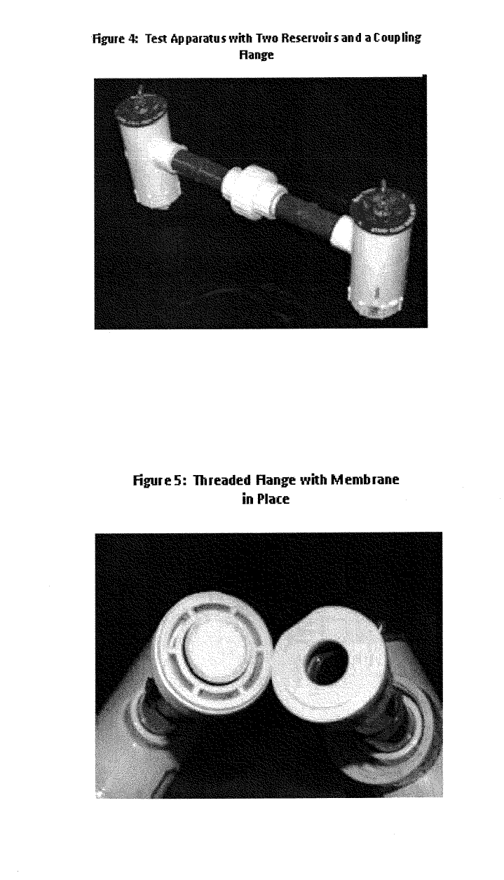

As seen in FIG. 4, the apparatus has two reservoirs, made from two inch PVC piping, to hold test solutions. The reservoirs were capped by screw-on rubber stoppers. The two reservoirs were connected by equal length sections of ¾ inch PVC piping with a threaded flange, displayed in FIG. 5, to hold the membrane sample in place and attach the two halves of the apparatus. Each PVC to PVC connection was threaded and the threads were wrapped with latex tape, to ensure tight seals.

To test the seals, throughout the apparatus as well as around the membrane, the apparatus was assembled with a sample membrane loaded. One reservoir was filled with 18 MΩ E-pure water and the other was left empty. The setup was allowed to stand for 5, 10 and 15 minute periods. At the end of each time period the apparatus was drained and disassembled. The side of the membrane not in contact with the water and the ¾ in PVC tubing from the dry side of the apparatus were investigated for moisture. This test offered one final practical check of the hydrophobic character of the membranes while also ensuring the integrity of the entire device. The test was repeated with a hydrogen peroxide solution.

Procedure 3: Apparatus-Membrane Seal Test
Seat a membrane onto the black O-ring of the flange
Screw the two halves of the apparatus together
Pour 175 mL of 18 MΩ E-pure water into one arm of the apparatus and screw the rubber stopper onto the apparatus.
Place on a shaker-table-to simulate the conditions of future experiments
Remove the apparatus from the shaker-table after five minutes and empty the reservoirs
Disassemble the apparatus
Examine the membrane and the side of the apparatus that was left dry for moisture
Repeat for 10 and 15 minute intervals
Repeat the entire experiment with a hydrogen peroxide solution made by adding 670 μL of 30% hydrogen peroxide to 200 mL of 18 MΩ E-pure water for the test solution

Before other characteristics of the membranes could be resolved, the apparatus to be used for our experiments had to be tested with the membranes in place. The apparatus was assembled with the membranes seated between the two flanges of the juncture. A reservoir was then filled with 18MΩ E-pure water and allowed to sit with an empty reservoir on the opposite side of the membrane. The test was run for five, 10, and 15 minutes intervals. At the end of each test, the apparatus was drained and disassembled. Once disassembled, it was inspected.

TABLE 3
Apparatus-Membrane Seal Test Results
Apparatus -Membrane Seal Testing

| Setup | Time | | Result |
|---|---|---|---|
| 18 MC2 E-Pure | 5 | Min. | No Visible Transport or Leaking |
| Water vs. Air | 10 | Min. | No Visible Transport or Leaking |
| | 15 | Min. | No Visible Transport or Leaking |
| 30% H₂O₂ vs. Air | 5 | Min. | No Visible Transport or Leaking |
| | 10 | Min. | No Visible Transport or Leaking |
| | 15 | Min. | No Visible Transport or Leaking |

The countertop that the experiment was run on was checked for any drops of water to ensure that the apparatus was not leaking. The side of the membrane that was not in contact with the filled reservoir was inspected for moisture. The channel on the portion of the apparatus that was left empty was inspected for moisture as well. As reported in Table 3, there was no observed leaking in any portion of the apparatus or transport of water across the membrane barrier. The test was also run with a hydrogen peroxide solution to once again check for leaks and conduct a final test of the membranes impermeability to water and hydrogen peroxide. The results, which can be found in Table 3, were the same as those for the water test.

Objective 2: Solution Preparations

In order to generate a concentration-absorbance curve, from which absorbance measurements could be converted into concentration measurements, varying solutions of calculated concentrations of MTBE were developed and then measured for absorbance. Solutions were also necessary for loading into the apparatus during each test. The solutions of MTBE created were 1000, 500, 250, 125 and 50 ppm. Table 4 shows the total volume of the solution, the amount of MTBE pipetted into the solution and the concentration of the MTBE in parts per million, ppm. All solutions will be prepared in a 300 ml flask and stirred for 20 minutes prior to being placed within the apparatus. Solutions below 50 ppm were not prepared because MTBE levels below 50 ppm approximate the levels set forth by the Environmental Protection Agency as acceptable.

TABLE 4
MTBE Solution Preparation

| | | |
|---|---|---|
| Total Volume | MTBE Volume | Concentration |

| | | | | |
|---|---|---|---|---|
| 250 mL | 340 | μL | 1000 | ppm |
| 250 mL | 170 | μL | 500 | ppm |
| 250 mL | 85 | μL | 250 | ppm |
| 250 mL | 34 | μL | 100 | ppm |
| 250 mL | 17 | gL | 50 | ppm |

Objective 3: MTBE Transport Across Polymer Membranes

Whether the various polymer membranes could, indeed, transport MTBE across its thickness was determined in addition to the organophilic character of each. In addition to testing the ability of the membranes to allow and foster the transport of MTBE, a comparison of the ability of the membranes to conduct that transport was made.

Concentration Profiles for MTBE Transport

The aforementioned aims were accomplished by measuring the concentration of an MTBE solution overtime while connected to a reservoir initially containing only water. Experiments were conducted over a period of thirty minutes with samples drawn initially and at five, 15, 25 and 30 minutes. Some experiments were run for longer periods of time. A spectrophotometer was utilized to assess the concentrations of the samples as they were drawn. Well-mixed solutions were maintained by keeping the apparatuses on a shaker-table that oscillated at a constant rate.

Procedure 4: Concentration Profiling for MTBE Transport
Prepare MTBE solution
Assemble the apparatus with sample membrane in place
Pour 175 mL of 1000 ppm MTBE solution into an appropriately labeled arm of the apparatus
Pour 175 mL of 18 MΩ E-pure water into the opposing arm of the apparatus and screw the rubber stoppers onto each reservoir after taking an initial sample
Place the apparatus on the shaker-table, and set the table to a low speed
Remove the apparatus and draw 3.25 mL samples from each arm of the apparatus at each preset interval; 5, 15, 25 and 30 minutes
Excrete the samples into individual vials for spectrophotometer analysis
Screw the rubber stopper onto both arms of the apparatus
Replace the apparatus on the shaker-table
At the conclusion of the testing period the MTBE solution must be disposed of in a hazardous waste container and the apparatus must be thoroughly cleaned

The polypropylene, nylon and Teflon membranes were tested over a thirty minute interval for their ability to selectively transport MTBE from a reservoir containing MTBE in solution to a reservoir containing only 18 MΩ E-pure water. 3.25 mL samples of the solution in the MTBE reservoir were taken and the concentrations were measured via a spectrophotometer.

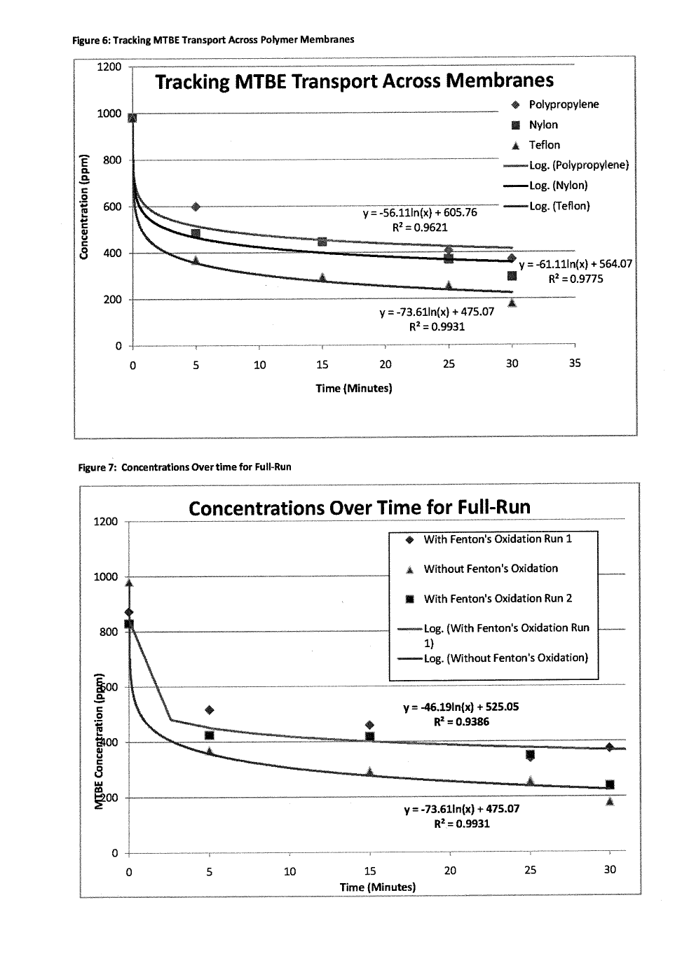

The results of those tests are reported in FIG. 6. As is clearly demonstrated by the data points for each membrane, the concentration in the MTBE reservoir decreased over time in all cases. Therefore, MTBE transport was possible and taking place through each membrane.

The rate of MTBE transport, the reduction in MTBE concentration per unit time, was expected to decrease over the course of the experiments. The driving force for the transportation of the MTBE across the membrane was the differential in concentration between the reservoirs. As the MTBE concentration in the upstream reservoir decreased and it increased in the downstream reservoir, the difference in concentration would also decrease. The smaller differential is tied directly to a smaller driving force and a decreased rate of MTBE transport. With decreasing rate of transport, the differential between the two reservoirs would decrease at ever lower rates, and so, as the system approached some equilibrium between the two reservoirs, the concentration was expected to asymptotically approach a level. Linear, polynomial, and exponential trend lines were generated for the data, but the fit with the highest R2 was a logarithmic trend line. From these lines of best fit, a comparison of the permeabilities of the three membranes to MTBE was made possible.

As seen in Table 5, polypropylene transport MTBE at the slowest rate, with a logarithmic factor of −56.1. Nylon transports MTBE at a higher rate, with a logarithmic factor of −61.1, but it is Teflon that exhibits the highest rate of transport. The logarithmic factor for Teflon, as calculated from our experimental results, was −73.6. Because Teflon displayed the highest rate of MTBE transport, the focus of the remainder of the project shifted to the Teflon film alone. The other membranes, nylon and polypropylene were not used in any subsequent tests.

TABLE 5
Logarithmic Lines of Best Fit for MTBE Transport to Water
Logarithmic Lines of Best Fit for MTBE Transport to Water Reservoir

| | | Logarithmic | |
|---|---|---|---|
| Membrane | Equation | Factor | Revalue |
| Nylon | y = −61.1 ln(x) + | −61.1 | 0.977 |
| | 564.0 | | |
| Polypropylene | y = −56.1 ln(x) + | −56.1 | 0.962 |
| | 605.7 | | |
| Teflon | y = −73.6 ln(x) + | −73.6 | 0.993 |
| | 475.0 | | |

Objective 4: MTBE Transport and Fenton's Oxidation

After removing the MTBE contamination from a water source, it must be degraded into lesser forms that do not conflict with health standards. Fenton's oxidation reactions, which are a specific set of oxidation reactions, have been shown to help meet that requirement of a remediation system. However, these reactions are quite aggressive and so polymer membranes used in the methods of the invention must be able to withstand attack by the solution. Only the membrane displaying the most rapid transport of MTBE in the previous round of testing was used in subsequent tests. The polymer membranes were tested via separate experiments to ensure that they did not allow the passage of iron ions or hydrogen peroxide.

Fenton's Oxidation in the Apparatus

Fenton's oxidation reactions take place when ferrous iron is in solution with hydrogen peroxide. To create this solution, FeSO₄.7H₂O was dissolved in water. Once the salt had completely dissolved, hydrogen peroxide was added. This solution presents two additional possible contaminants to the remediation system. The contamination of the MTBE/water side with iron or hydrogen peroxide is not acceptable and so they must not pass through the membrane. Having tested the membrane's ability to prevent the passage of iron ions and hydrogen peroxide, tests could be conducted with Fenton's oxidation taking place in one reservoir and MTBE transport from the opposing, membrane-separated, reservoir.

Iron Ion Tracking Across Teflon Membrane

The passage of ferrous iron and hydrogen peroxide from one reservoir to the other, across the membrane, was tested in a pair of overnight tests. For the iron-based test, a solution of FeSO₄.7H₂O in water was created. The combined solution was added to a reservoir on the apparatus. The opposing reservoir was filled with 18 MΩ E-pure water and the two stoppers were put into place to seal the apparatus. The device was placed on a shaker-table for 24 hours to allow a significant opportunity for transport of iron ions across the membrane. The presence of iron ions in the water side of the apparatus at the end of the experiment was tested lay adding sodium bicarbonate. From a list of solubility rules it was determined that sodium does not form a precipitate with SO₄²⁻ but Fe²⁺ does form a precipitate with HCO₃²⁻. Therefore any iron in solution would precipitate out in the presence of the added salt. The same experiment was conducted with a hydrogen peroxide solution. The presence of hydrogen peroxide in the water side of the apparatus at the end of the experiment was tested by adding FeSO₄.7H₂O, because the addition of hydrogen peroxide to a solution containing ferrous iron generates a clearly distinguishable brown precipitate, 30% hydrogen peroxide was added to the liquid contained in the “water” side of the apparatus with formation of a precipitate signaling iron transport and the absence of a precipitate highlighting the absence of iron.

Brief control experiments were conducted to assess the validity of our claim that precipitates would form in the presence of the added salts. When the down-stream water side solutions were poured from the apparatus into beakers, the up stream solutions were also poured into beakers as well. The upstream solutions contained the compounds of interest for each run. Solutions containing the salts, FeSO₄.7H₂O and NaHCO₃ were added to the upstream solutions. In each case, a clearly distinguishable precipitate formed and settled out of solution.

Procedure 5: Blocking Ferrous Iron Transport
Assemble the apparatus with sample membrane in place
Weigh and add 44.78 grams of FeSO₄.7H₂O to 200 mL of 18 MΩ E-pure water
Allow the solution to mix on a stir plate until all of the iron salt has dissolved
Pour 175 mL of the iron solution into a reservoir arm on the apparatus
Fill the opposing side with 175 mL of 18 MΩ E-pure water and secure the rubber stoppers onto each reservoirs
Place the assembly onto a shaker-table and allow to stand for 24 hours
At the end of the 24 hour period, remove the apparatus from the shaker-table
Drain the water side of the apparatus into a 500 mL beaker
Dissolve 10 grams of NaHCO₃ into 50 mL of 18 MΩ E-pure water
Add the NaHCO₃ solution to the to 500 mL beaker
Look for and make note of any precipitation
Dispose of the solutions appropriately and thorough cleanse the apparatus

Procedure 6: Blocking Hydrogen Peroxide Transport
Assemble the apparatus with sample membrane in place
Add 670 μL of 30% hydrogen peroxide to 200 mL of 18 MΩ E-pure water
Allow the solution to mix on a stir plate until all salt has dissolved
Pour 175 mL of the hydrogen peroxide solution into a reservoir arm on the apparatus
Fill the opposing side with 175 mL of 18 MS) E-pure water and secure the rubber stoppers onto each reservoirs
Place the assembly onto a shaker-table and allow to stand for 24 hours
At the end of the 24 hour period, remove the apparatus from the shaker-table
Drain the waterside of the apparatus into a 500 mL beaker
Dissolve 5 grams of FeSO₄.7H₂O into 50 mL of 18 MΩ E-pure water
Add the FeSO₄.7H₂O solution to the to 500 mL beaker
Look for and make note of any precipitation
Dispose of the solutions appropriately and thorough cleanse the apparatus

Isolated Solution Transport for Teflon Membrane

The Teflon membrane was tested to ensure that it was capable of blocking the passage of ferrous iron ions as well as hydrogen peroxide, the two components of Fenton's oxidation solution. Individual aqueous solutions of ferrous iron and hydrogen peroxide were allowed to stand in the apparatus for a 24 hour period. The opposing reservoir was filled with water and at the end of the testing period, the water-side solution was tested for the presence of the respective component. The presence of iron or hydrogen peroxide was tested by adding to the solution a salt that would result in the formation of precipitate in combination with the component of interest. As displayed in Table 5, the salts added to the hydrogen peroxide-based test and the ferrous iron-based test were FeSO₄.7H₂O and NaHCO₃ respectively. The addition of the salt did not evolve a precipitate in either case and therefore no transport of hydrogen peroxide or iron was taking place across the membrane boundary. Therefore, in a test involving Fenton's oxidation solution, the components are restricted to the reservoir that they were initially poured into and would not contaminate the solution in the other reservoir.

TABLE 6
Transport of Fenton's Oxidation Solution Components
Apparatus - Isolated Solution Transport Testing for Teflon Membrane

| Solution | Additive | Reaction | Conclusion |
|---|---|---|---|
| 30% H₂O₂ in 18 | FeSO₄•7H₂O | No Reaction | No Transport |
| MΩ E-Pure Water | | | |
| FeSO₄•7H₂O | NaHCO₃ | No Reaction | No Transport |

MTBE Transport into Fenton's Oxidation

Having proven that MTBE can pass through the pores of a particular hydrophobic polymer membrane while preventing the passage of iron ions and hydrogen peroxide in solution, tests with MTBE in being removed from one reservoir to be remediated in the other were conducted. A 1000 ppm solution of MTBE was prepared and poured into the assembled apparatus with a membrane loaded. An iron solution was created and hydrogen peroxide was added to it. Samples were drawn over the course of thirty minutes as well as at the end of longer periods of time. The test allowed a comparison of the transfer characteristics of the membrane with and without degradation of MTBE. It also allowed an investigation of attack on the membrane surface by the oxidizing solution as MTBE entered into the remediation solution.

Procedure 7: MTBE Transport into Fenton's Oxidation
Assemble the apparatus with a sample membrane loaded
Prepare MTBE and FeSO₄.7H₂O solutions
Pour 175 mL of desired MTBE solution into the right arm of the apparatus
Pour 175 mL of FeSO₄.7H₂O solution into the left arm of the apparatus (1-to-56.18 molar MTBE/FeSO₄.7H₂O ratio)
Pipette 670 μL of H₂O₂ into the left arm of the apparatus (1-to-10.06 molar MTBE/H₂O₂ ratio)
Screw the rubber stopper onto the right arm of the apparatus
Cover the reservoir on the left arm of the apparatus with Para-film
Place the apparatus on a shaker-table set at a low speed
Remove the apparatus and draw 2.50 mL samples from each arm of the apparatus at each preset interval; 5, 15, 25 and 30 minutes
Transfer the samples into individual micro COD testing vials
Replace the reservoir covers on both arms of the apparatus
Replace the apparatus on the shaker-table
Shake the micro COD vial
Analyze the solution using micro COD testing
Dispose of the solutions appropriately and thorough cleanse the apparatus

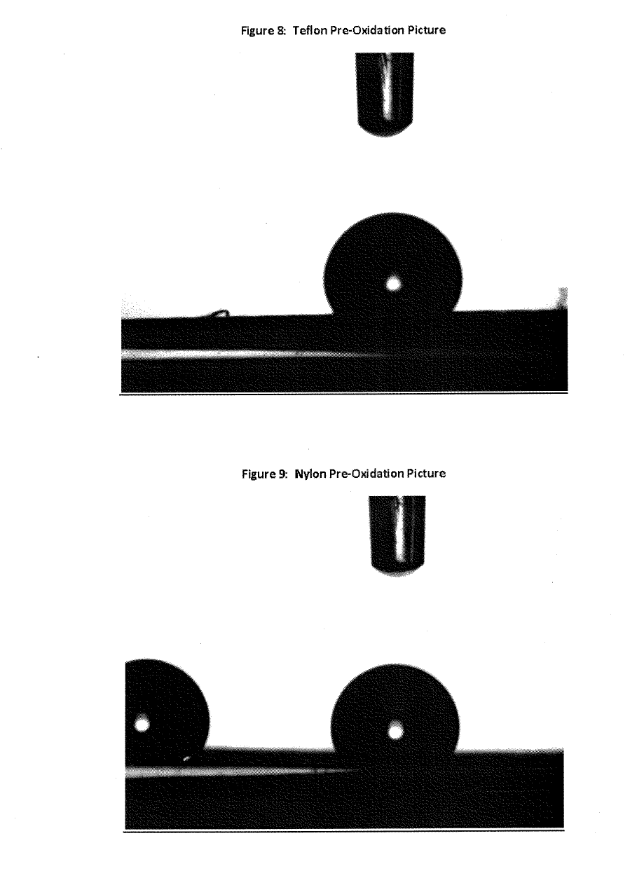

A full proof of concept run was conducted to ensure that MTBE transport was indeed possible from a MTBE solution reservoir into a reservoir containing Fenton's oxidation solution. The test was conducted over the same span of time, with samples drawn at the same intervals in the previous experiments. Theoretically, as the MTBE transported across the polymer membrane, it should have been destroyed by the oxidizing agents in the down-stream reservoir, maintaining only a very small concentration of MTBE in that reservoir. This effect should have provided for a linear declination of the driving force between the two reservoirs due to concentration gradient. However, as shown in FIG. 7, the removal of MTBE from the solution occurred in along a logarithmic trend line, much the same way that the transport occurred in the in the absence of the Fenton's oxidation solution. The trend line plotted FIG. 7 was calculated from the values from four runs. Two pairs of runs were conducted, with each of the duplicate apparatuses created for experimentation being utilized. The values measured for the two apparatuses were averaged, leaving two sets of data points to be plotted. The logarithmic coefficient for the equation of the trend line generated for the data points was significantly lower than that generated in the previous objective. The value generated for MTBE into water was −46.19 and the value for MTBE in Fenton's oxidation solution was −73.61. There was some reddish-brown staining on some of the membranes at the conclusion of the tests. The stains may well have been deposited iron that had the effect of clogging the pores of the membrane and therefore slowing the transport of MTBE across the polymer boundary.

Tracking Temperature Change in the Reservoirs

The concentration of MTBE in the reservoir containing Fenton's oxidizing agents could not be measured because of the presence of the other components in solution. Therefore, the removal of MTBE from the MTBE reservoir could not be tracked into the opposing reservoir. The oxidation of MTBE has a heat of reaction, and so, if the MTBE was oxidized the temperature of the oxidizing solution would increase as the reaction progressed. If the MTBE is evaporating over the course of the reaction, a corresponding temperature decrease might be exhibited. By measuring the temperatures of the two constituent solutions, of MTBE and hydrogen peroxide with ferrous iron, if there is a temperature change when the two are separated by a membrane, it is because of MTBE transport and oxidation.

Procedure 8: MTBE and 18 MΩ E-pure water Heat of Reaction testing
Assemble the apparatus with a membrane loaded
Make 175 mL of 1000 ppm MTBE solution and let it come to room temperature. Pour into the right arm.
Obtain 175 mL of 18 MΩ E-pure water and let it come to room temperature and then pour it into the left arm of the apparatus.
Cover each reservoir with parafilm and poke a hole in the center of the parafilm
Place a thermometer in each hole of the parafilm
Record temperature readings at 5, 10 and 15 minutes
Dispose of the solutions appropriately and thoroughly cleanse the apparatus

Procedure 9: Fenton's solution and 18 MΩ E-pure water Heat of Reaction testing
Assemble the apparatus with a membrane loaded
Obtain 175 mL of 18 MΩ E-pure water and let it come to room temperature. Pour into the right arm of the apparatus
Make 175 mL of FeSO₄.7H₂O solution
Pipette 670 μL of 30% H₂O₂ into iron solution
Let the solution come to room temperature and then pour it into the left arm of the apparatus
Cover each reservoir with parafilm and poke a hole in the center of the parafilm
Place a thermometer in each hole of the parafilm
Record temperature readings at 5, 10 and 15 minutes
Dispose of the solutions appropriately and thoroughly cleanse the apparatus

Procedure 10: MTBE and Fenton's solution Heat of Reaction testing
Assemble the apparatus with a membrane loaded
Make 175 mL of 1000 ppm MTBE solution and let it come to room temperature
Pour the solution into the right arm of the apparatus
Make 175 mL of FeSO₄.7H₂O solution and add to it 670 μL of H₂O₂
Allow the solution to come to room temperature before pouring it into the left arm of the apparatus
Cover each reservoir with parafilm and poke a hole in the center of the parafilm
Place a thermometer in each hole of the parafilm
Record temperature readings at 5, 10 and 15 minutes
Dispose of the solutions appropriately and thoroughly cleanse the apparatus

Tracking Temperature Change in the Reservoirs

The tests involving both MTBE and Fenton's oxidation solution, in separate reservoirs of the same apparatus, suggested that MTBE transport and oxidation of that MTBE were occurring in conjunction with one another. However, to test whether the only reaction taking place during the testing period was oxidation of MTBE, the temperatures of the solutions over the course of the experiment were compared to baseline values, with changes in temperature indicating reactions generating heats. Temperature readings were taken over a twenty-five minute period.

TABLE 7
Heat of Reaction Test Results
Apparatus - Heat of Reaction Test

Temperature (° C.)

| Setup | Time | | Side 1 | Side 2 |
|---|---|---|---|---|
| 18 MΩ E-Pure | 5 | Min. | 21.7 | 21.7 |
| Water (1) vs. | 10 | Min. | 21.7 | 21.7 |
| Fenton's | 15 | Min. | 21.7 | 21.7 |
| Oxidation | | | | |
| Solution (2) | | | | |
| 18 MΩ E-Pure | 5 | Min. | 21.7 | 21.7 |
| Water (1) vs. | 10 | Min. | 21.7 | 21.7 |
| 1000 ppm MTBE | 15 | Min. | 21.7 | 21.7 |
| Solution (2) | | | | |
| Fenton's | 5 | Min. | 21.7 | 21.7 |
| Oxidation | 10 | Min. | 22.2 | 21.7 |
| Solution (1) vs. | 15 | Min. | 22.5 | 21.7 |
| 1000 ppm MTBE | 20 | Min. | 22.6 | 21.7 |
| Solution (2) | 25 | Min. | 22.6 | 21.7 |

No change in temperature was measured when a MTBE solution was allowed to sit in the apparatus with a membrane separating it from a reservoir containing water. The same result was seen when Fenton's oxidation solution was allowed to stand in the same setup as the MTBE solution. When the Fenton's oxidation solution and MTBE solutions were both loaded into the apparatus, in different reservoirs, a temperature change of approximately one degree was seen over the twenty-five minute timeframe. These results are summarized in Table 7 and indicate that the oxidation of MTBE occurring.

Contact Angle Measurement after Prolonged Exposure to Fenton's Oxidation

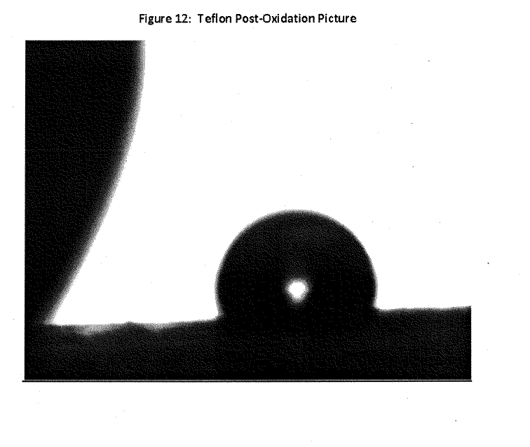

The experiments progressed from the initial tests to assure the hydrophobicity of the polymer membranes, to a full test of the remediation of a MTBE contaminated solution by a strong oxidizing solution separated by one of those same membranes. However, destruction of the membrane by the oxidizing solution presents a serious threat to the viability of hydrophobic polymer use in industrial-scale remediation efforts. Each membrane was investigated visually for degradation after each exposure to the Fenton's oxidation solution. In an effort to quantify the potential breakdown of the membrane by the oxidizing agent, a post-use goniometer-based contact angle measurements were conducted for comparison to the initial values (FIG. 12).

Procedure 11: Contact Angle Measurement After Exposure to Oxidation
Load the apparatus with a membrane and 1000 ppm MTBE solution and Fenton's oxidation solution
Allow the apparatus to stand on a shaker-table for a full 48 hour period
Remove the apparatus from the shaker-table and drain the reservoirs
Disassemble the apparatus, remove and cleanse the membrane with 18 MΩ E-pure water
Follow all steps of Procedure 2

The Teflon membranes, after exposure to a strong oxidizing solution for a period of time no less than 48 hours, were tested again for the ability to repel water. The hydrophobic nature of the membranes was characterized by the contact angle measured for a drop of 18 MΩ E-pure water on the membrane surface. The range for the contact angle measurements of the Teflon membrane after exposure was 109.2 to 135.9 degrees (Table 8). The mean contact angle, for the four measured values was 120.5 degrees, which closely compares to the initial value mean contact angle of 120.2 degrees, certainly well within the standard deviation of the measurements. Because of the close agreement of the two values, it was concluded that no change in the hydrophobicity of the membrane occurred.

TABLE 8
Contact Angle Measurements for Teflon Membrane
after Fenton's Oxidation Exposure
Goniometer Contact Angle Measurements
after Fenton's Oxidation Exposure

| Test | 0.45 μm Pore |
|---|---|
| Membrane | Teflon |
| Trial 1 | 109.2 |
| Trial 2 | 118.4 |
| Trial 3 | 135.9 |
| Trial 4 | 118.4 |
| Average | 120.5 |

### CONCLUSIONS

Of the four polymer membranes that were initially procured for testing, only three actually exhibited hydrophobic character. The Teflon, Nylon, and polypropylene membranes, which were proven to be hydrophobic, were tested for the ability to be permeated by MTBE. All three selectively transported MTBE and a comparison of the concentration reductions over time highlighted the Teflon membrane as having the greatest permeability to the contaminant. The Teflon membranes, when bound between an oxidizing solution, of ferrous iron ions and hydrogen peroxide, and MTBE in water, maintained their semi permeable characteristics. However, the concentration of MTBE in the MTBE solution was not reduced as drastically when paired with the oxidizing solution, as when paired with water. Staining was displayed on the membranes at the end of the test cycles involving the oxidizing solution containing iron. Given this phenomenon, the conclusion was drawn that iron deposits were clogging the polymer pores, limiting transport of MTBE. A simple means of cleansing the membrane surface of deposition should be performed periodically.

The pTFE (Teflon) membrane used, while supported, was rather frail due to its thickness. The limitations of using thicker, more structurally sound forms of the membrane must be investigated for the development of an industrial scale remediation effort. A multiple pass tube exchanger would offer a large surface area for MTBE transport, as well as a dedicated area for the oxidizing solution. However, the Teflon tubes would have to be able be structurally sound enough to maintain form while also maintaining functionality.

### APPENDIX A

### MicroCOD Testing Procedure

Preheat the MicroCOD incubator to 150° C.
Appropriately label a COD testing vial
Draw a 2.5 mL sample using a 1-to-5 μL pipette
Excrete 2.5 mL of test solution into a MicroCOD vial.
Shake the MicroCOD vial vigorously
Place the vial within the COD incubator and set the timer for 2 hours
Remove the MicroCOD vial from the incubator
Unscrew vial cap and draw a 3.25 mL sample
Excrete the sample into a spectrophotometer blank
Zero the spectrophotometer using an empty blank
Take a spectrophotometer reading
Record the reading

### APPENDIX B

### MTBE/Hydrogen Peroxide Ratio Calculations

### MTBE:

$$340 μ L \times \frac{{10}^{- 3} mL}{1 μ L} \times \frac{0.74 g}{1 mL} \times \frac{mole}{88 g} = 2.859 \times {10}^{- 3} moles$$

### Hydrogen Peroxide:

$$670 μ L \times \frac{{10}^{- 3} mL}{1 μ L} \times \frac{1.46 g}{1 mL} \times \frac{mole}{34 g} = 2.877 \times {10}^{- 2} moles$$

The ratio is

$$\frac{Hydrogen Peroxide}{MTBE} = \frac{2.877 \times {10}^{- 2} moles}{2.859 \times {10}^{- 3} moles} = 10.06$$

For every mole of MTBE, there are 10.06 moles of Hydrogen Peroxide

### APPENDIX C

### MTBE/FeSO₄.7H₂O Solution Ratio Calculations

1000 ppm solution of MTBE:

$$340 μ L \times \frac{{10}^{- 3} mL}{1 μ L} \times \frac{0.74 g}{1 mL} \times \frac{mole}{88 g} = 2.859 \times {10}^{- 3} moles$$

### FeSO₄.7H₂O Solution:

$$44.78 g \times \frac{mole}{277.9 g} = 0.161 moles$$

The ratio is

$$\frac{MTBE}{FeSO 4 \cdot 7 H 2 O} = \frac{2.859 \times {10}^{- 3} moles}{0.161 moles} = 0.0178$$

For every mole of a 1000 ppm solution of MTBE, there are 56.18 moles of FeSO₄.7H₂O.

### APPENDIX D

### Hydrogen Peroxide/FeSO₄.7H₂O Solution Ratio Calculations

### Hydrogen Peroxide:

$$670 μ L \times \frac{{10}^{- 3} mL}{1 μ L} \times \frac{1.46 g}{1 mL} \times \frac{mole}{34 g} = 2.877 \times {10}^{- 2} moles$$

FeSO₄.7H₂O solution:

$$44.78 g \times \frac{mole}{277.9 g} = 0.161 moles$$

The ratio is

$$\frac{Hydrogen Peroxide}{FeSO 4 \cdot 7 H 2 O} = \frac{2.877 \times {10}^{- 2} moles}{0.161 moles} = 0.179$$

For every mole of a Hydrogen Peroxide, there are 5.59 moles of FeSO₄.7H₂O

### APPENDIX E

### MTBE Concentration to Absorbance Calibration Curve

TABLE 9
Calibration Curve for MTBE Concentration vs Absorbance
Calibration Curve for MTBE Contention vs Absorbance

| Concentration | |
|---|---|
| (ppm) | Absorbance |
| 1000 | 0.0576 |
| 500 | 0.0559 |
| 250 | 0.0558 |
| 125 | 0.0553 |
| 50 | 0.0551 |

### APPENDIX F

### MicroCOD MTBE Concentration to Absorbance Calibration Curve

TABLE 10
COD Testing Absorbance vs MTBE Concentration
COD Testing Absorbance vs MTBE Concentration Curve

| Concentration of | |
|---|---|
| MTBE(ppm) | Absorbance |
| 1000 | 0.84 |
| 500 | 1.326 |
| 250 | 1.8251 |
| 125 | 3.663 |
| 50 | 4.3665 |
| 0 | 4.49 |

What is claimed is:

1. A method for removing an organic contaminant from water, comprising:
(i) passing a water stream through a hydrophobic and organophilic polymer membrane, such that the membrane repels said water stream while allowing said organic contaminant to pass through the membrane;
(ii) separating said organic contaminant from said water, and
(iii) reacting said organic contaminant with an oxidation reagent.

2. The method of claim 1, wherein said polymer membrane is polytetrafluoroethylene (Teflon®).

3. The method of claim 1, wherein said polymer membrane has pore sizes of approximately 0.45 microns.

4. The method of claim 1, wherein said oxidation reagent is composed of ferrous iron and hydrogen peroxide.

5. The method of claim 4, wherein the pH of said ferrous iron and hydrogen peroxide is approximately 3.

6. The method of claim 1, wherein said oxidation reagent is used to produce hydroxyl radicals.

7. The method of claim 1, wherein said organic contaminant is methyl-tert-butyl ether (MTBE).

8. The method of claim 1, further comprising:
(iv) periodically cleaning the surface of said polymer membrane.
